(19) United States
(12) Patent Application Publication
(10) Pub. No.: US 2026/0142569 A1
(43) Pub. Date: May 21, 2026

(54) CONTROLLER FOR SWITCHING CONVERTER

(71) Applicant: Renesas Design (UK) Limited, Bourne End (GB)

(72) Inventors: Eduardas JODKA, Germering (DE); Miroslav HUKEL, Alling (DE)

(73) Assignee: Renesas Design (UK) Limited, Bourne End (GB)

(21) Appl. No.: 18/949,043

(22) Filed: Nov. 15, 2024

(51) Int. Cl. H02M 3/158; H02M 1/00

(52) U.S. Cl. CPC H02M 3/158; H02M 1/0009

(57) ABSTRACT

A controller for a switching converter is provided. The switching converter includes one or more power switches and an inductor. The controller is configured to drive a switching operation of the one or more power switches to provide a magnetization phase where an inductor current flowing through the inductor increases to a peak current value that is dependent on the load current, and a demagnetization phase where the inductor current decreases from the peak current value. The controller includes a switch driving circuit configured to provide one or more switch driving signals, and a load current determination circuit configured to receive a first signal that is dependent on the load current and adjust the one or more switch driving signals using the first signal to provide the peak current value that is dependent on the load current.

### FIELD

The present disclosure relates to a controller for a switching converter.

### BACKGROUND

Switched-mode DC/DC converters achieve output voltage regulation by duty-cycling the power stage in a controlled manner. There are numerous output voltage regulation schemes that may be selected based on the requirements of a system.

One possible regulation scheme is a direct control scheme. In the case of such a control scheme, the output voltage is directly sensed by a comparator and then the switching activity takes place as soon as the output voltage falls below the set target.

Typically, direct-control regulators operate exclusively in discontinuous-conduction mode (DCM), however there are known techniques where continuous-conduction mode (CCM) can also be achieved (e.g., by adding a generated ramp signal).

In DCM, inductor current is always limited to positive values, and every switching cycle ends with inductor current reaching zero, before the next switching cycle can take place.

FIG. 1 is a schematic of a known direct-control DC/DC boost converter 100.

As seen in FIG. 1, an output voltage V_{OUT} is being directly sensed by a main comparator 102 through a feedback divider comprising resistors R_{fb1}, R_{fb2}. A feedback divider is commonly used for adjusting the sensing biasing point.

The main comparator 102 compares the sensed output voltage V_{OUT} with a target reference V_{ref} and the comparator 102 triggers if the output voltage V_{OUT} falls below the reference V_{ref}.

The main comparator output signal V_{comp} is subsequently processed by a logic block 104, which controls the switching of a power stage. In this example the power stage comprises low-side M_{LS} and high-side M_{HS} power FETs. The power FETs are being steered by corresponding gate-drivers 106, 108.

FIG. 1. Shows both power FETs M_{LS}, M_{HS} as being of N-type, however, the high-side is commonly implemented as a P-type device. A Ton timer 110 can be used for setting the duration of the inductor L magnetization phase whereas a zero comparator 112 senses the inductor current during the demagnetization phase and triggers as the current reaches zero.

FIG. 2 is a timing graph 200 showing example waveforms for a practical implementation of the direct-control converter 100 as shown in FIG. 1.

Inductor current pulses I_{coil} having different amplitudes are presented. A typical switching cycle starts with the output voltage Vₒᵤₜ falling below the target reference V_{ref}, resulting in the comparator 102 flag coming high V_{comp}. Triggering of the comparator 102 flag starts the magnetization phase of the inductor L, which takes place for a duration of an on-time tₒₙ and ends when the on-timer triggers Vₜₒₙ, at which point the inductor current reaches its peak value.

De-magnetization phase follows for the duration of an off-time t_{off} and it finishes when the inductor current reaches zero, which is being detected by the zero-current comparator 112. Zero current detection event is denoted as V_{zero}.

In the case of a boost converter, the energy is being transferred to the output during the de-magnetization phase. The amount of energy transferred depends on the amplitude of the inductor peak current (assuming that the inductor current slope is constant). Namely, the larger the peak current, the more energy is delivered. The amount of energy delivered to the output translates to the output voltage ripple, i.e. the output voltage ripple is greater for a higher peak current than a lower peak current.

### SUMMARY

It is desirable to provide an improved controller for a switching converter.

According to a first aspect of the disclosure there is provided a controller for a switching converter for receiving an input voltage, generating an output voltage and providing a load current to an electrical load, the switching converter comprising one or more power switches, and an inductor, wherein the controller is configured to drive a switching operation of the one or more power switches to provide i) a magnetization phase where an inductor current flowing through the inductor increases to a peak current value that is dependent on the load current, and ii) a demagnetization phase where the inductor current decreases from the peak current value, the controller comprises a switch driving circuit configured to provide one or more switch driving signals, each of the one or more switch driving signals being configured to control the switching state of one of the one or more power switches, thereby driving the switching operation of the one or more power switches, and a load current determination circuit configured to receive a first signal that is dependent on the load current, and adjust the one or more switch driving signals using the first signal to provide the peak current value that is dependent on the load current.

Optionally, the peak current value is proportional to the load current.

Optionally, the first signal is one of the switch driving signals, and the load current determination circuit comprises a high pass filter configured to filter the first signal, and a current modulator configured to receive the first signal after filtering, convert the first signal from frequency information to current information that is proportional to the load current, and adjust the one or more switch driving signals using the first signal after conversion.

Optionally, the switch driving circuit comprises an on-time circuit configured to set a duration of the magnetization phase, wherein the load current determination circuit is configured to control the duration of the magnetization phase set by the on-time circuit depending on the first signal, thereby adjusting the one or more switch driving signals using the first signal to provide the peak current value that is dependent on the load current.

Optionally, the switch driving circuit comprises a logic circuit configured to provide the one or more switch driving signals, and the on-time circuit is configured to set the duration of the magnetization phase by providing an on-time signal to the logic circuit.

Optionally, the controller comprises a zero comparator configured to detect when the inductor current is approximately zero, and to provide a signal to the logic circuit indicating the end of the demagnetization phase.

Optionally, the controller comprises a comparator configured to receive a feedback voltage that is dependent on the output voltage, receive a reference voltage, compare the feedback voltage and the reference voltage, and provide a comparator output signal that is dependent on the comparison between the feedback voltage and the reference voltage, wherein the logic circuit is configured to receive the comparator output signal and to provide the one or more switch driving signals that are each dependent on the comparator output signal.

Optionally, the first signal is one of the switch driving signals, and the load current determination circuit comprises a high pass filter configured to filter the first signal, and a current modulator configured to receive the first signal after filtering, convert the first signal from frequency information to current information that is proportional to the load current, and adjust the one or more switch driving signals using the first signal after conversion.

Optionally, the current modulator is configured to apply the first signal to the comparator as a variable bias current to reduce a propagation delay of the comparator.

Optionally, the switch driving circuit comprises a peak current sensing circuit configured to sense the inductor current, compare the inductor current to a reference peak current value, switch the switching operation from the magnetisation phase to the demagnetisation phase when the inductor current is approximately equal to the reference peak current value, wherein the load current determination circuit is configured to adjust the reference peak current value depending on the first signal, thereby adjusting the one or more switch driving signals using the first signal to provide the peak current value that is dependent on the load current.

Optionally, the switch driving circuit comprises a logic circuit configured to provide the one or more switch driving signals, and the peak current sensing circuit is configured to adjust the reference peak current by providing a peak current reference adjustment signal to the logic circuit.

Optionally, the controller comprises a zero comparator configured to detect when the inductor current is approximately zero, and to provide a signal to the logic circuit indicating the end of the demagnetization phase.

Optionally, the controller comprises a comparator configured to receive a feedback voltage that is dependent on the output voltage, receive a reference voltage, compare the feedback voltage and the reference voltage, and provide a comparator output signal that is dependent on the comparison between the feedback voltage and the reference voltage, wherein the logic circuit is configured to receive the comparator output signal and to provide the one or more switch driving signals that are each dependent on the comparator output signal.

Optionally, the switching converter is a buck converter, a boost converter or a buck-boost converter.

Optionally, the switching converter is a boost converter, and the power switches comprises a high side switch and a low side switch.

Optionally, the controller comprises a switch driving circuit configured to provide a high side switch driving signal to the high side switch, and provide a low side switch driving signal to the low side switch, wherein the high and low side switch driving signals are configured to control the switching state of their respective power switches, thereby driving the switching operation of the power switches.

Optionally, the high pass filter comprises a first resistor coupled to a first capacitor via a first switch, the first capacitor being coupled to the first switch at a filter output node, a second resistor coupled to the filter output node via a second switch, wherein the first switch is configured to be driven by a first digital signal that is in a high state when the switching converter is operating in a tri-state phase and is otherwise in a low state, and the second switch is configured to be driven by a second digital signal that is in a high state during the demagnetization phase and is otherwise in a low state, and the high pass filter is configured to provide the filtered first signal to the current modulator at the filter output node.

Optionally, the current modulator comprises a source degeneration resistor coupled to a first transistor via a first low resistance switch, a gate of the first transistor being coupled to the filter output node, a current mirror comprising a second transistor coupled to the first transistor via a first node, a third transistor having its gate coupled to a gate of the second transistor at a second node, and configured to provide a first modulation current at a current modulator output node, a fourth transistor having a first terminal coupled to a second low resistance switch, a second terminal coupled to a biasing resistor at the second node, and a gate coupled to the first node, and a third low resistance switch coupled to the first node, wherein the first and second low resistance switches are each configured to be driven by the first signal and the third low resistance switch is configured to be driven by an inverted first signal, and the current modulator is configured to adjust the one or more switch driving signals using the first modulation current, thereby adjusting the one or more switch driving signals using the first signal after conversion.

Optionally, the switch driving circuit comprises an on-time circuit configured to set a duration of the magnetization phase, wherein the load current determination circuit is configured to control the duration of the magnetization phase set by the on-time circuit depending on the first signal using the first modulation current, thereby adjusting the one or more switch driving signals using the first signal to provide the peak current value that is dependent on the load current.

Optionally, the switch driving circuit comprises a logic circuit configured to provide the one or more switch driving signals, the on-time circuit is configured to set the duration of the magnetization phase by providing an on-time signal to the logic circuit, and the controller comprises a comparator configured to receive a feedback voltage that is dependent on the output voltage, receive a reference voltage, compare the feedback voltage and the reference voltage, and provide a comparator output signal that is dependent on the comparison between the feedback voltage and the reference voltage, wherein the logic circuit is configured to receive the comparator output signal and to provide the one or more switch driving signals that are each dependent on the comparator output signal.

Optionally, the current modulator comprises a fifth transistor having its gate coupled to the gate of the first transistor, and a third resistor coupled in series with the fifth transistor, wherein the third resistor and the fifth transistor are configured to generate a variable bias current, wherein the current modulator is configured to apply the first signal to the comparator as the variable bias current to reduce a propagation delay of the comparator.

Optionally, the switch driving circuit comprises a peak current sensing circuit configured to sense the inductor current, compare the inductor current to a reference peak current value, switch the switching operation from the magnetisation phase to the demagnetisation phase when the inductor current is approximately equal to the reference peak current value, wherein the load current determination circuit is configured to adjust the reference peak current value depending on the first signal using the first modulation current, thereby adjusting the one or more switch driving signals using the first signal to provide the peak current value that is dependent on the load current.

According to a second aspect of the disclosure there is provided a power converter system comprising a switching converter for receiving an input voltage, generating an output voltage and providing a load current to an electrical load, the switching converter comprising one or more power switches, and an inductor, and a controller configured to drive a switching operation of the one or more power switches to provide i) a magnetization phase where an inductor current flowing through the inductor increases to a peak current value that is dependent on the load current, and ii) a demagnetization phase where the inductor current decreases from the peak current value, the controller comprises: a switch driving circuit configured to provide one or more switch driving signals, each of the one or more switch driving signals being configured to control the switching state of one of the one or more power switches, thereby driving the switching operation of the one or more power switches, and a load current determination circuit configured to receive a first signal that is dependent on the load current, and adjust the one or more switch driving signals using the first signal to provide the peak current value that is dependent on the load current.

It will be appreciated that the power converter of the second aspect may include features as set out in relation to the first aspect and may include other features as described herein, in accordance with the understanding of the skilled person.

According to a third aspect of the disclosure there is provided a method of controlling a switching converter for receiving an input voltage, generating an output voltage and providing a load current to an electrical load, the switching converter comprising one or more power switches, and an inductor, wherein the method comprises driving a switching operation of the one or more power switches using a controller to provide i) a magnetization phase where an inductor current flowing through the inductor increases to a peak current value that is dependent on the load current, and ii) a demagnetization phase where the inductor current decreases from the peak current value, providing, using a switch driving circuit, one or more switch driving signals, each of the one or more switch driving signals being configured to control the switching state of one of the one or more power switches, thereby driving the switching operation of the one or more power switches, and receiving, at a load current determination circuit, a first signal that is dependent on the load current, and adjusting, using the load current determination circuit, the one or more switch driving signals using the first signal to provide the peak current value that is dependent on the load current.

It will be appreciated that the method of the third aspect may include providing and/or using features of the first and/or second aspects, and may include other features as described herein in accordance with the understanding of the skilled person.

### BRIEF DESCRIPTION OF THE DRAWINGS

The disclosure is described in further details below by way of example and with reference to the accompanying drawings, in which:

FIG. 1 is a schematic of a known direct-control DC/DC boost converter;

FIG. 2 is a timing graph showing example waveforms for a practical implementation of the direct-control converter as shown in FIG. 1;

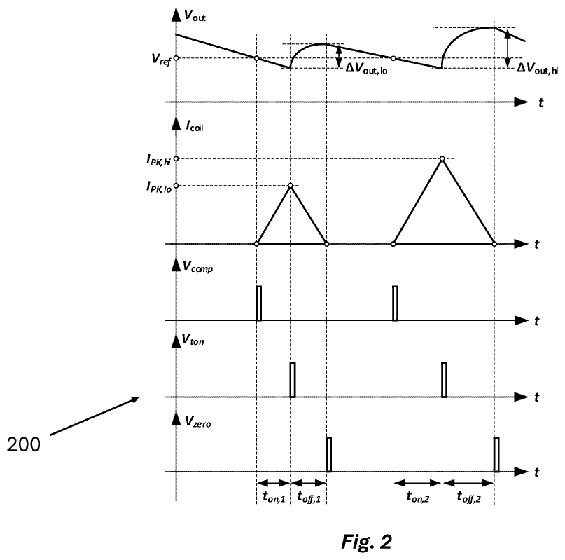

FIG. 3 is a timing graph showing inductor currents for a practical implementation of the converter of FIG. 1;

FIG. 4A is a schematic of a controller for a switching converter in accordance with a first embodiment of the present disclosure, FIG. 4B is a timing graph showing an inductor current during operation for a practical implementation of the switching converter, FIG. 4C is a timing graph showing the relationship between peak current and load current for a specific embodiment of the present disclosure, FIG. 4D is a schematic of a specific embodiment of the controller in accordance with a second embodiment of the present disclosure;

FIG. 5 is a schematic of a specific embodiment of the controller and the switching converter in accordance with a third embodiment of the present disclosure;

FIG. 6 is a schematic of a specific embodiment of the controller and the switching converter in accordance with a fourth embodiment of the present disclosure;

FIG. 7 is a graph showing load transient simulation results for a practical implementation of the controller and the switching converter as presented in FIG. 6;

FIG. 8 is a graph showing further load transient simulation results for a practical implementation of the controller and the switching converter as presented in FIG. 6;

FIG. 9A is a schematic of a specific embodiment of the on time circuit, FIG. 9B shows simulation results for a practical implementation of the controller and the switching converter of FIG. 5 using the specific embodiment of the on time circuit of FIG. 9A;

FIG. 10 is a schematic of a specific embodiment of the load circuit determination circuit and the on time circuit as may be implemented in the embodiment presented in FIG. 5;

FIG. 11 shows simulation results for a practical implementation of the controller and the switching converter of FIG. 5 using the specific embodiment of the on time circuit and the load current determination circuit as presented in FIG. 10; and

FIG. 12 is a schematic of a specific embodiment of the controller and the switching converter in accordance with a fifth embodiment of the present disclosure;

FIG. 13 is a schematic of a specific embodiment of the load current determination circuit; and

FIG. 14 shows simulation results for a practical implementation of the controller and the switching converter of FIG. 12 using the specific embodiment of the load current determination circuit as presented in FIG. 13.

### DETAILED DESCRIPTION

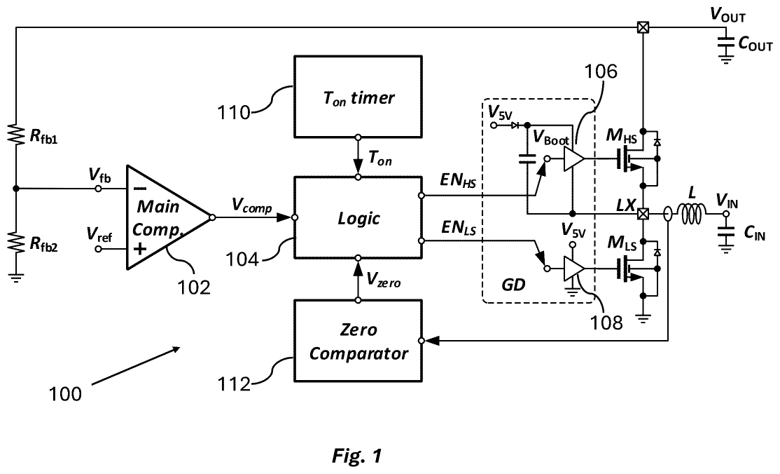

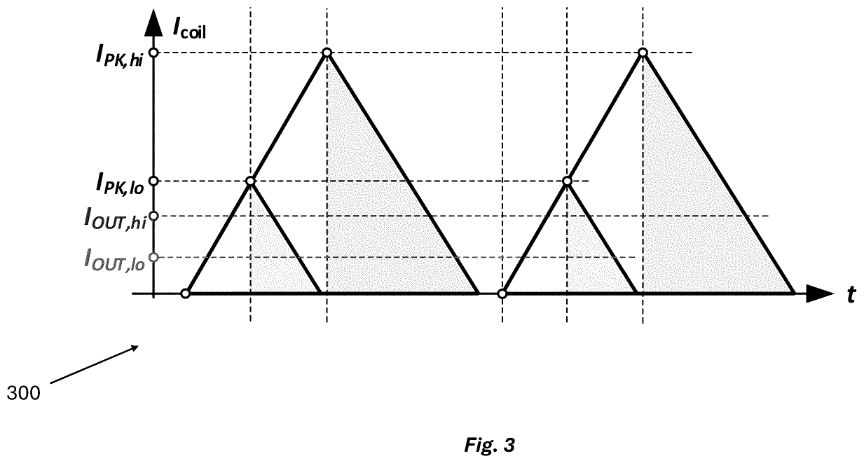

FIG. 3 is a timing graph 300 showing inductor currents for a practical implementation of the converter 100 of FIG. 1. Specifically, there is shown example converter inductor current patterns having different peak current amplitudes and the corresponding delivered output load currents.

Typically, a small output voltage ripple is desired, which means a less noisy regulated output voltage. Inductor current pulses having a smaller peak current are needed to achieve smaller output voltage ripple.

The output load current, that can be delivered by the converter 100, is proportional to the inductor peak current amplitude of individual pulses.

Two inductor peak current amplitude scenarios (I_{PK,lo} and I_{PK,hi}) are shown in FIG. 3 for the converter 100 operating in DCM—in both cases the switching frequency is the same, as well as the inductor current slope (same operating point). A boost converter configuration is assumed, meaning that the energy is delivered to the output only during the de-magnetization phase.

The output load current I_{OUT,hi} is the output load current for the peak current amplitude I_{PK,hi}, and the output load current I_{OUT,lo} is the output load current for the peak current amplitude I_{PK,lo}. The output load current is higher for the scenario with a higher inductor peak current.

Therefore, in the case of direct-control converters operating in DCM, there is a tradeoff in having a small output voltage ripple and a high output current capability. DCM operation is desirable in direct-control converters, because this operational mode has a superior transient performance allowing extremely fast output voltage recovery to system perturbations (i.e. load and line transients). The output load capability in DCM, however, is typically limited, due to the above-mentioned tradeoff related to the output voltage ripple.

Therefore, it is desirable to have an output voltage regulation system, which only operates with high inductor peak currents at high output loads, and otherwise has small inductor peak currents to achieve a small output voltage ripple. Known systems conventionally use a compensation scheme, which would slow down the transient response of the system and would need a certain die area. Furthermore, a compensation scheme would also consume certain quiescent current, thereby impacting light load efficiency of the converter.

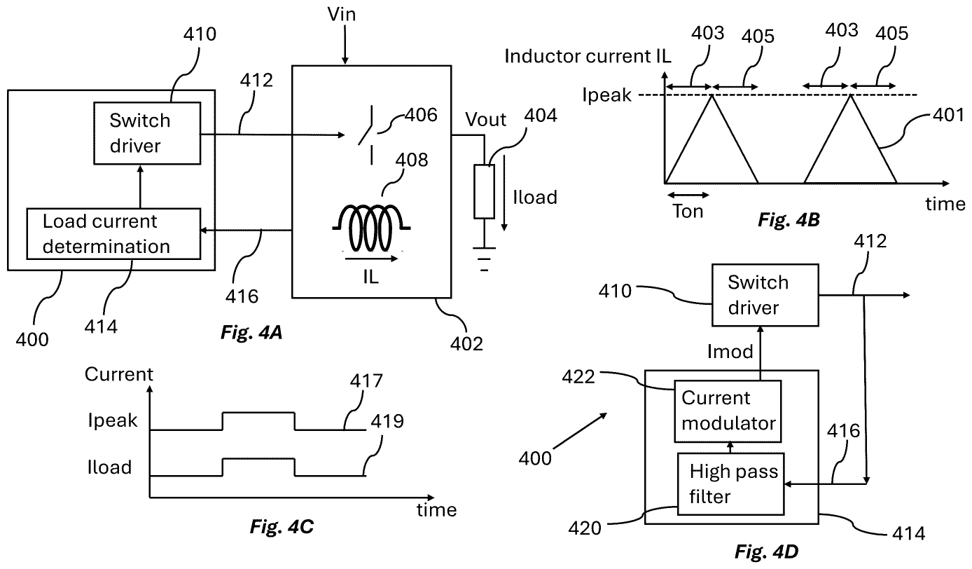

FIG. 4A is a schematic of a controller 400 for a switching converter 402 in accordance with a first embodiment of the present disclosure. During operation, the switching converter 402 receives an input voltage Vin, generates an output voltage Vout and provides a load current Iload to an electrical load 404.

The switching converter 400 comprises one or more power switches 406 and an inductor 408.

FIG. 4B is a timing graph showing an inductor current IL (a trace 401) flowing through the inductor 408 during operation for a practical implementation of the switching converter 400.

The controller 400 is configured to drive a switching operation of the one or more power switches 406 to provide:
a magnetization phase (labelled 403) where an inductor current IL flowing through the inductor 408 increases to a peak current value Ipeak that is dependent on the load current Iload; and
a demagnetization phase (labelled 405) where the inductor current IL decreases from the peak current value Ipeak.

By alternating the inductor 408 between magnetization and demagnetization phases through the driving of the one or more power switches 406, the input voltage Vin is used to generate the output voltage Vout.

The duration of the magnetization phase may be a time period Ton referred to as the “on time”.

The switching converter 402 may, for example, be a buck converter, a boost converter or a buck-boost converter.

The controller 400 comprises a switch driving circuit 410 that is configured to provide one or more switch driving signals 412, each of the one or more switch driving signals 412 being configured to control the switching state of one of the one or more power switches 406, thereby driving the switching operation of the one or more power switches 406.

In the present example, there is illustrated a single switching driving signal 412 that is provided to a single power switch 406. The “switching state” refers to the conductive state of the switch 406. For example, in an “on state” the switch 406 may permit a current to flow, and in an “off state” the switch 406 may prevent the current from flowing.

The controller 400 further comprises a load current determination circuit 414 that is configured to receive a first signal 416 that is dependent on the load current Iload, and adjust the one or more switch driving signals 412 using the first signal 416 to provide the peak current value Ipeak that is dependent on the load current Iload.

In a specific embodiment, the first signal 416 may be one of the switch driving signals 412. In a further embodiment, the first signal 416 may be derived from, or dependent on, at least one of the switch driving signals 412.

It will be appreciated that it is not necessary for the load current determination circuit 414 to extract the value of the load current Iload from the first signal 416. The role of the load current determination circuit 414 is to receive the first signal 416 that is dependent on the load current Iload and then, using the first signal 416, adjust the switch driving signals 412 to provide the peak current value Ipeak that is dependent on the load current Iload. As there is a relationship between the load current Iload and the first signal 416, it is sufficient to use the first signal 416 itself for the adjustment without having to extract the load current value from the first signal 416 for the adjustment.

FIG. 4C is a timing graph showing the relationship between peak current Ipeak (a trace 417) and load current Iload (a trace 419) for a specific embodiment of the present disclosure. The peak current value Ipeak may, for example, be proportional to the load current Iload.

FIG. 4D is a schematic of a specific embodiment of the controller 400 in accordance with a second embodiment of the present disclosure. In the present embodiment, the first signal 416 is one of the switch driving signals 412. In a further embodiment, the first signal 416 may be dependent on, or otherwise derived from, at least one of the switch driving signals 412.

In the present embodiment, the load current determination circuit 414 comprises a high pass filter 420 configured to filter the first signal 416 and a current modulator 422 that is configured to receive the first signal 416 after filtering, and to convert the first signal 416 from frequency information to current information Imod that is proportional to the load current Iload. The current modulator 422 is further configured to adjust the one or more switch driving signals 412 using the first signal 416 after it has been converted to the current information Imod.

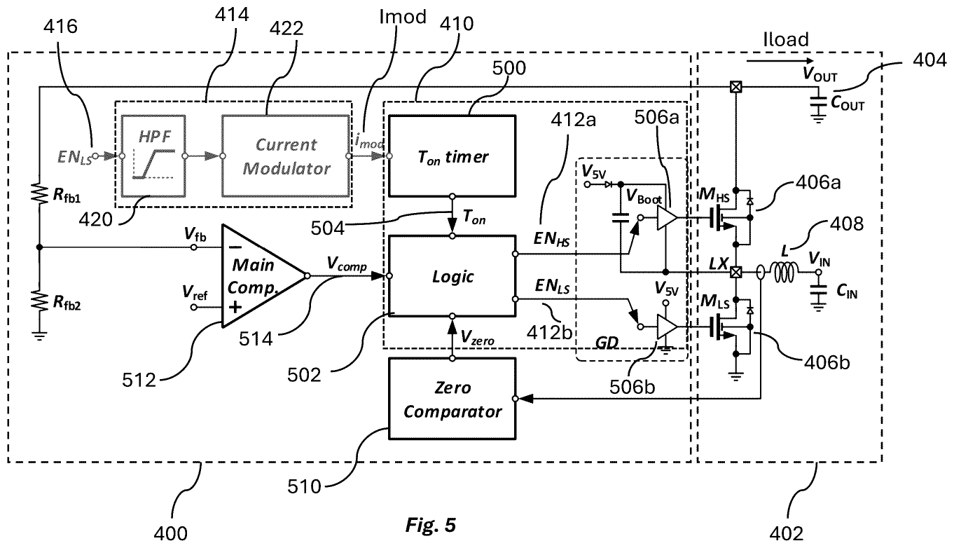

FIG. 5 is a schematic of a specific embodiment of the controller 400 and the switching converter 402 in accordance with a third embodiment of the present disclosure. In the present embodiment, the switching converter 402 is a boost converter. The switching converter 402 may comprise an input capacitor CIN. The power switches 406 comprise a high side switch 406a and a low side switch 406b. During operation, the switch driving circuit 410 provides the switching driving signals 412 comprising a high side driving signal 412a to the high side switch 406a and a low side driving signal 412b to the low side switch 406b.

In the present example, both power FETs 406a, 406b are shown as being of N-type. However, in further embodiments, one or both of the switches 406a, 406b may be implemented using P-type transistors.

In the present embodiment, the switch driving circuit 410 comprises an on-time circuit 500 that is configured to set a duration Ton of the magnetization phase. During operation, the load current determination unit 414 controls the duration Ton of the magnetization phase set by the on-time circuit 500 depending on the first signal 416. This results in an adjustment of one or both of the switch driving signals 412a, 412b using the first signal 416, to provide the peak current value Ipeak that is dependent on the load current Iload.

The switch driving circuit 410 may comprise a logic circuit 502 configured to provide one or both of the switch driving signals 412a, 412b. The on-time circuit 500 may set the duration of the magnetization phase Ton by providing an on time signal 504 to the logic circuit 502.

In the present embodiment, the switch driving signal 412a is provided to a gate driver 506a which sets the voltage level of the switch driving signal 412a to a sufficient level to drive the switching operation of the high side switch 406a.

In the present embodiment, the switch driving signal 412b is provided to a gate driver 506b which sets the voltage level of the switch driving signal 412b to a sufficient level to drive the switching operation of the low side switch 406b.

The controller 400 may comprise a zero comparator 510 configured to detect when the inductor current IL is approximately zero, and to provide a signal Vzero to the logic circuit 502 indicating the end of the demagnetization phase. The controller 400 may further comprise a comparator 512 configured to receive a feedback voltage Vfb that is dependent on the output voltage Vout, receive a reference voltage Vref, and compared the feedback voltage Vfb with the reference voltage Vref. The comparator 512 is further configured to provide a comparator output signal 514 that is dependent on the comparison between the feedback and reference voltages Vfb, Vref. In the present embodiment, the feedback voltage Vfb is generated by providing the output voltage Vout to a resistor divider comprises resistors Rfb1, Rfb2.

During operation, the logic circuit 502 may receive the comparator output signal 512 and provide the switch driving signals 412a, 412b depending on the comparator output signal 512.

The present embodiment of the switching converter 402 functions as a direct-control DC/DC boost converter having an output current proportional modulation of the Ton timer 500 as provided by the controller 400.

During operation, the controller 400 generates an output current proportional information. This is achieved by employing the high pass-filter (HPF) 420. During operation, the high pass filter 420 receives digital information about the converter switching activity.

As shown in the present example, such digital information can be provided by the low-side switch control signal 412b.

In a further embodiment, the information may be provided by the high-side switch control signal 412a or any other suitable signal in accordance with the understanding of the skilled person.

In the present embodiment, the first signal 416 is provided by the low side switch driving signal 412b. If the converter 402 needs to deliver a higher output load current Iload, it switches more often, and the low-side control signal 412b is toggling at a higher frequency, alternatively, if there is no load Iload at the output—the converter 402 needs to switch less, and the low-side control signal 412b is toggling at a lower frequency. This way, switching activity of the converter 402 translates to information about the current Iload at its output.

As a next step, the frequency domain information about the converter load current Iload, as provided via the high pass filter 420, is converted to a more practical signal, either voltage or current, so that it can be directly applied to relevant sub-blocks inside of the controller 400.

In the present embodiment the current modulator 422 converts the frequency information to a proportional current information Imod. In summary, a higher converter switching activity corresponds to a higher modulation current and vice-versa.

The modulation current Imod is applied to the on time circuit 500. As discussed previously, the on time circuit 500 sets the duration Ton of the magnetization phase of the switching converter 402. By applying the modulation current Imod, the duration of the magnetization phase can be extended, resulting in larger inductor peak currents Ipeak. Since the modulation current Imod is proportional to the converter load current Iload, the result is that the converter 402 operates with larger peak currents Ipeak as the output current Iload increases.

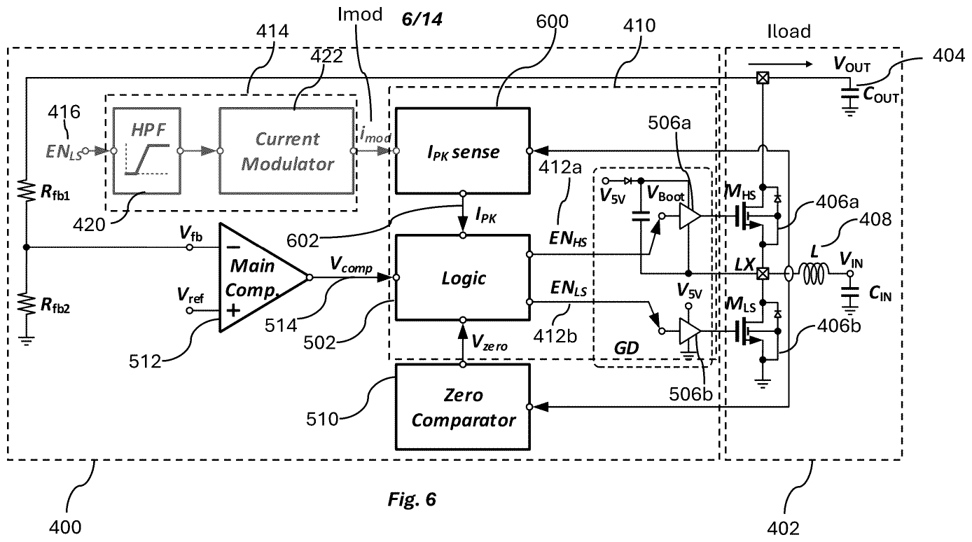

FIG. 6 is a schematic of a specific embodiment of the controller 400 and the switching converter 402 in accordance with a fourth embodiment of the present disclosure. In the present embodiment, and compared with the embodiment presented in FIG. 5, the on time circuit 500 is omitted and the switch driving circuit 410 comprises a peak current sensing circuit 600. During operation, the peak current sensing circuit 600 senses the inductor current IL, compares the inductor current IL to a reference peak current value, and switches the switching operation from the magnetization phase to the demagnetization phase when the inductor current IL is approximately equal to the reference peak current value.

The load current determination circuit 414 may be configured to adjust the reference peak current value depending on the first signal 416, thereby adjusting the switch driving signals 412a, 412b using the first signal 416 to provide the peak current value Ipeak that is dependent on the load current Iload.

The peak current sensing circuit 600 may be configured to adjust the reference peak current by providing a peak current reference adjustment signal 602 to the logic circuit 502.

The present embodiment of the switching converter 402 functions as a direct-control DC/DC boost converter having an output current proportional modulation of the peak current value as provided by the peak current sensing circuit 600 of the controller 400.

As in the case when the modulation current Imod is applied to the on time circuit 500 of the embodiment presented in FIG. 5, such modulation current Imod can also be applied to the peak current sensing block 600 of the present embodiment. In this case, the peak current Ipeak of the converter 402 is being directly sensed and compared against a certain predefined reference. The triggering of the peak current sensing block 600 happens when the inductor current value IL reaches the reference. The peak current sensing event finishes the magnetization phase of the converter 402. The modulation current Imod may, for example be added or subtracted from the reference peak current value, thereby modulating the inductor current point, at which the peak current sense block 600 triggers.

The resulting effect is identical to that of Ton-timer modulation provided by the embodiment presented in FIG. 5: the magnetization phase gets extended for higher converter load currents Iload. Therefore, the generated modulation current Imod can be applied to a Ton-timer (the on time circuit 500) as well as to the peak current sense block (the peak current sensing block 600), thereby introducing converter peak current dependency on the output load current Iload.

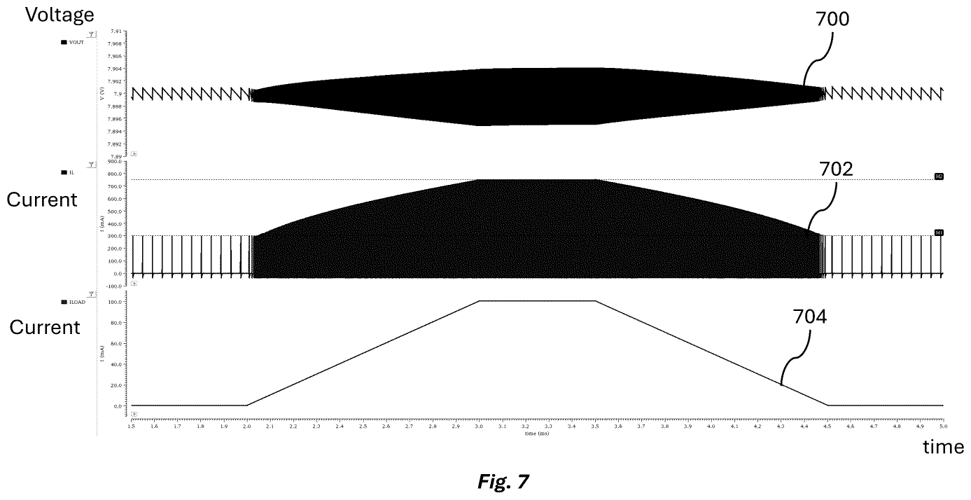

FIG. 7 is a graph showing load transient simulation results for a practical implementation of the controller 400 and the switching converter 402 as presented in FIG. 6. There is shown: the output voltage VOUT (a trace 700), the inductor current IL (a trace 702) and the load current Iload (a trace 704).

The parameters for the simulation are as follows: V_{IN}=3.8V, V_{OUT}=7.9V, L=2.2 μH, C_{OUT,eff}=12 μF, I_{OUT}=0.5 mA→100 mA.

It will be appreciated that simulation results for a practical implementation of the controller 400 and the switching converter 402 of FIG. 5 will exhibit a similar profile to the waveforms as presented in FIG. 7.

In the present example, a relatively slow output load transient is performed, where 100 mA is being slowly applied to the output of the switching converter 402 (within 1 ms). The switching converter 402 itself regulates the output voltage Vout of 7.9V, while its input voltage Vin is 3.8V. Initially, as the load current Iload is low, the switching converter 402 switches with a certain constant peak current Ipeak of approximately 300 mA. As the load current Iload starts increasing, the peak current Ipeak increasing proportionally, and it reaches 750 mA at the load current Iload of 100 mA. It will be appreciated that the exact values of inductor peak current are arbitrary, and in this example it only serves to illustrate the principle behind the proposed implementation, where the converter peak current Ipeak is proportional to its output load current Iload.

The result of the peak current increasing with increasing load current is a larger converter output current capability—if the peak current is kept fixed (as is the case in known systems), the converter would not be able to support the maximum load current in the presented example.

As shown in FIG. 7 the result of the proposed DC/DC converter peak current proportionality to the output load current Iload is an increase in the output voltage Vout ripple, since the converter 402 produced larger inductor current pulses. Output voltage Vout ripple can be reduced by introducing a larger output capacitor (the electrical load 404, also labelled C_{OUT}).

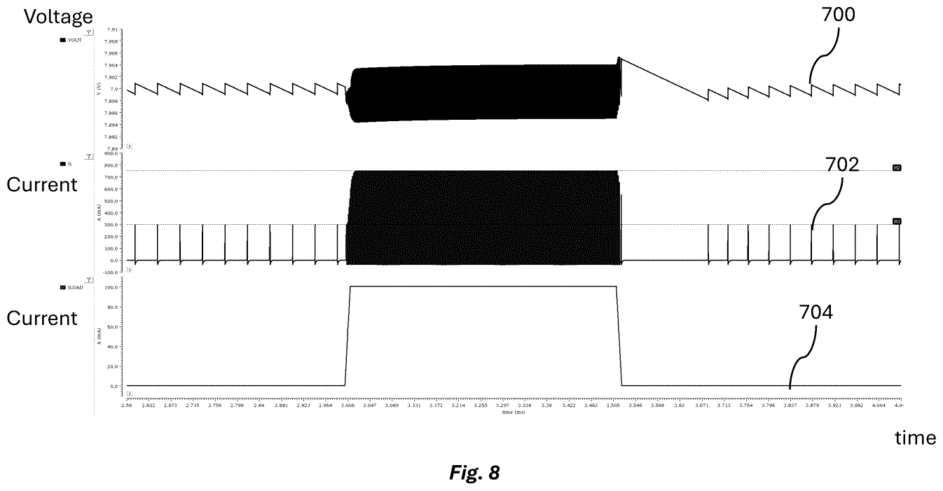

FIG. 8 is a graph showing further load transient simulation results for a practical implementation of the controller 400 and the switching converter 402 as presented in FIG. 6. There is shown: the output voltage VOUT (a trace 800), the inductor current IL (a trace 802) and the load current Iload (a trace 804).

The parameters for the simulation are as follows: VIN=3.8V, VOUT=7.9V, L=2.2 μH, COUT,eff=12 μF, IOUT=0.5 mA→100 mA

It will be appreciated that simulation results for a practical implementation of the controller 400 and the switching converter 402 of FIG. 5 will exhibit a similar profile to the waveforms as presented in FIG. 8.

A benefit of having the switching converter 402 output load capability being proportional to the output load itself, and having its inductor peak current Ipeak being adaptive based on the load current Iload, is that the converter 402 can keep operating in discontinuous conduction mode (DCM) even at high loads. It is well known that DC/DC converters respond to transients (e.g., line or load) substantially better in DCM operation as compared to the continuous conduction mode (CCM) operation.

An example simulation of a relatively fast load transient is depicted in FIG. 8. In the present case the load step of 100 mA is applied within 10 μs. As can be seen from FIG. 8, the converter 402 instantaneously reacts to the transient by having its inductor peak current Ipeak increased proportional to the load current Iload, this way, no output voltage VOUT undershoot can be observed. As the load current Iload is being removed from the output, the inductor peak current Ipeak returns to its low value to ensure small output voltage VOUT ripple in converter 402 light-load operation.

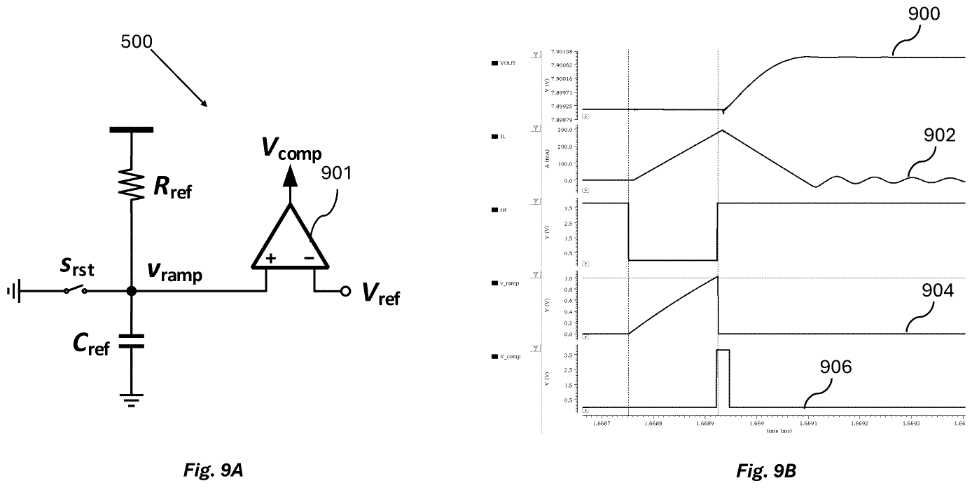

FIG. 9A is a schematic of a specific embodiment of the on time circuit 500. In the present embodiment, the on time circuit 500 comprises a comparator 901 reference capacitor C_{ref}, which, during operation, is charged by the reference resistor R_{ref}. Outside of the magnetization phase (e.g., during the de-magnetization phase), the reference capacitor C_{ref} is discharged by a reset switch sᵣₛₜ. Charging of the reference capacitor C_{ref} creates a ramp-signal across it: vᵣₐₘₚ. The time constant R_{ref}C_{ref} defines the slope of the ramp to the first degree. Once the ramp signal vᵣₐₘₚ reaches a certain reference voltage, V_{ref}, the comparator triggers, changing the logic state of the V_{comp} signal, which, in turn, indicates the end of the converter magnetization phase.

FIG. 9B shows simulation results for a practical implementation of the controller 400 and the switching converter 402 of FIG. 5 using the specific embodiment of the on time circuit 500 of FIG. 9A. There is shown: the output voltage VOUT (a trace 900), the inductor current IL (a trace 902), a reset signal (a trace 904), the ramp signal vᵣₐₘₚ (a trace 906), and the comparator output signal V_{comp} (a trace 908).

As the output voltage VOUT of the converter 402 falls below a desired target, a new switching cycle is triggered. The switching cycle starts with A magnetization phase, during which, current IL in the inductor increases. At the same time, the reset signal of the switch sᵣₛₜ goes LOW, releasing the top plate of the reference capacitor C_{ref}, and allowing it to be charged. Once the ramp signal vᵣₐₘₚ reaches the reference voltage V_{ref}, the comparator 901 triggers, indicating that the magnetization phase must stop, and the converter 402 needs to enter the de-magnetization phase. The duration of the on-time sets the peak current value of the inductor 408.

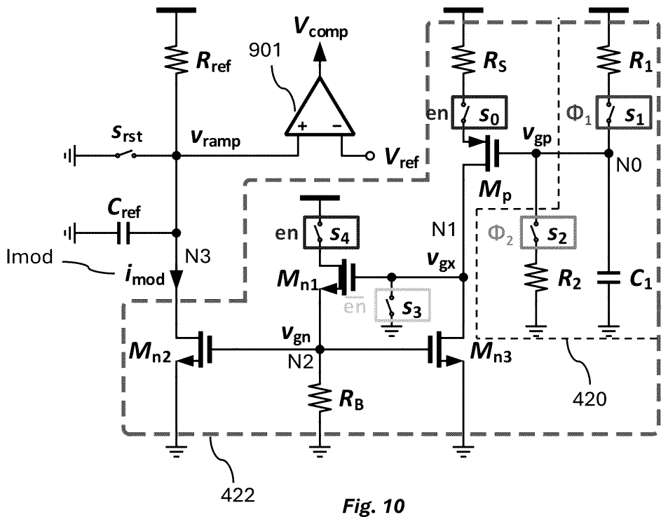

FIG. 10 is a schematic of a specific embodiment of the load circuit determination circuit 414 and the on time circuit 500 as may be implemented in the embodiment presented in FIG. 5.

The high pass filter 420 comprises a resistor R₁ coupled to a capacitor C₁ via a switch S₁, the capacitor C₁ being coupled to the switch S₁ at a filter output node. The high pass filter 420 further comprises a resistor R₂ coupled to the filter output node N0 via a switch S₂. The switch S₁ is configured to be driven by a digital signal Φ₁ that is in a high state when the switching converter 402 is operating in a tri-state phase and is otherwise in a low state. The second switch S₂ is configured to be driven by a digital signal Φ₂ that is in a high state during the demagnetization phase and is otherwise in a low state.

One or both of the digital signals Φ₁, Φ₂ may be the first signal 416. In a further embodiment one or both of the digital signals Φ1, Φ2 may be derived from, or dependent on, the first signal 416. In a specific embodiment, the first signal 416 may be derived from, or dependent on, at least one of the switch driving signals 412.

The high pass filter 420 is configured to provide the filtered first signal to the current modulator at the filter output node N0.

The current modulator 422 comprises a source degeneration resistor Rₛ coupled to a transistor M_{P} via a low resistance switch S₀, a gate of the transistor M_{P} being coupled to the filter output node N0. The current modulator 422 comprises a current mirror comprising a transistor Mₙ₃ coupled to the first transistor M_{P} via a first node N1, and a transistor Mₙ₂ having its gate coupled to a gate of the transistor Mₙ₃ at a second node N2, and configured to provide the modulation current Imod at a current modulator output node N3.

The current modulator 422 further comprises a transistor Mₙ₁ having a first terminal coupled to a low resistance switch S₄, a second terminal coupled to a biasing resistor R_{B} at the second node N2, and a gate coupled to the first node N1; and a low resistance switch S₃ coupled to the first node N1.

The low resistance switches S₀, S₄ are each configured to be driven by the first signal 416 and the low resistance switch S₃ is configured to be driven by an inverted first signal. The current modulator 422 is configured to adjust the one or more switch driving signals 412a, 412b using the modulation current Imod, thereby adjusting the one or more switch driving signals 412a, 412b using the first signal 416 after conversion from frequency information to current information. In the present embodiment, the first signal 416 is the high side switch driving signal 412a.

In the present embodiment, a converter output load dependent modulating current is generated and applied to the on time circuit 500. The components of the present embodiment may be summarized as follows:
R₁—filtering resistance
C₁—filtering capacitance
R₂—resistance for setting the discharge rate of the capacitor C₁
R_{S}—source degeneration resistance for setting the transconductance
R_{B}—biasing resistance
M_{P}—PMOS device for voltage to current conversion
Mₙ₁—NMOS device providing fast node start-up
M_{n2,3}—NMOS current mirror structure
S₀₋₄—low-resistive switches

The devices R₁, R₂ and C₁, as well as the switches s_{1,2} form the high-pass filter 420. The high-pass filter 420 structure generates a node voltage v_{gp}, which is then converter to a current by the PMOS device M_{P}. The transconductance for the voltage to current conversion is defined by the source degeneration resistor R_{S}. The current is then mirrored through the NMOS mirroring structure M_{n2,3} generating the modulation current Imod.

The circuit, apparat from the high pass filter, may be kept in a disabled state until the switching cycle starts, thereby not introducing additional current consumption, and not affecting the converter efficiency by inclusion of the circuit.

For this reason, a very fast wake-up is required. Such wake-up is ensured by the NMOS device Mₙ₁ and the biasing resistor R_{B}. In addition to modulating the converter peak current proportional to the output load, the modulating current can be applied to various system sub-blocks, improving the performance.

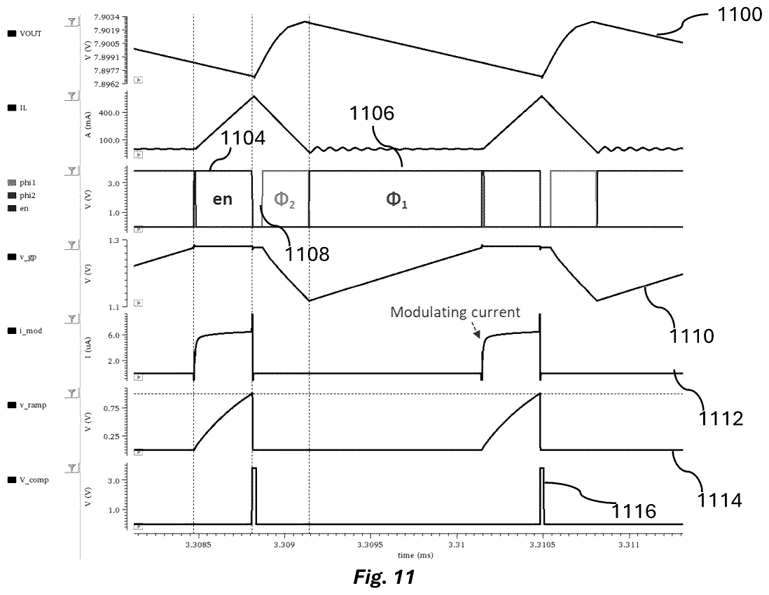

FIG. 11 shows simulation results for a practical implementation of the controller 400 and the switching converter 402 of FIG. 5 using the specific embodiment of the on time circuit 500 and the load current determination circuit 414 as presented in FIG. 10. There is shown the output voltage (a trace 1100), the inductor current IL (a trace 1102), the first signal 416 (a trace 1104), the digital signal Φ1 (a trace 1106), the digital signal Φ2 (a trace 1108), the node voltage v_gp (a trace 1110), the modulation current Imod (a trace 1112), the ramp voltage v_ramp (a trace 1114) and the comparator output v_comp (a trace 1116).

The operation of the present embodiment may be summarized as follows:
As the output voltage of the converter falls below a desired target, a new switching cycle is being triggered
The switching cycle starts with magnetization phase, during which, current in the inductor is increasing. The duration of the magnetization phase is defined by the Ton-timer
The digital signal Φ₁ goes LOW, resulting in the high-pass filter signal v_{gp} being held constant. Also, ‘en’ signal goes HIGH, enabling voltage to current conversion as well as the fast wake-up structure. Here signals controlling switches s₃ & s₄ are complementary (‘en’ & ‘en-bar’)
The modulating current starts flowing and it is being applied to the Ton-timer
The capacitor of the Ton-timer is being charged at a reduced rate due to the modulation current. Once the ramp signal reaches the reference voltage, comparator triggers, indicating that the magnetization phase must stop, and the converter needs to enter the de-magnetization phase. The duration of the on-time sets the peak current value of the inductor. In this case the peak current is higher because of the Ton-timer modulation
As the converter enters the de-modulation phase, the digital signal Φ₂ goes HIGH, resulting in the capacitor C₁, as part of the high-pass filtering, is being discharged through R₂
De-magnetization phase continues until the inductor current reaches zero. At which point the converter enters tri-state, where both, the low-side and the high-side switches are OFF
During the tri-state, the digital signal Φ₁ goes HIGH, resulting in the capacitor C₁, as part of the high-pass filtering, is being charged through R₁. The charging continues until the next switching cycle, where the entire process is being repeated

In the present example, the modulation of the om time circuit 500 is implemented. As shown in in FIG. 10, the modulation current Imod is applied to the top plate of the reference capacitor C_{ref}, “stealing” the charging current away. If the modulation current Imod is high, the charging rate of the ramp is lower, and the Ton-time is being prolonged as a result.

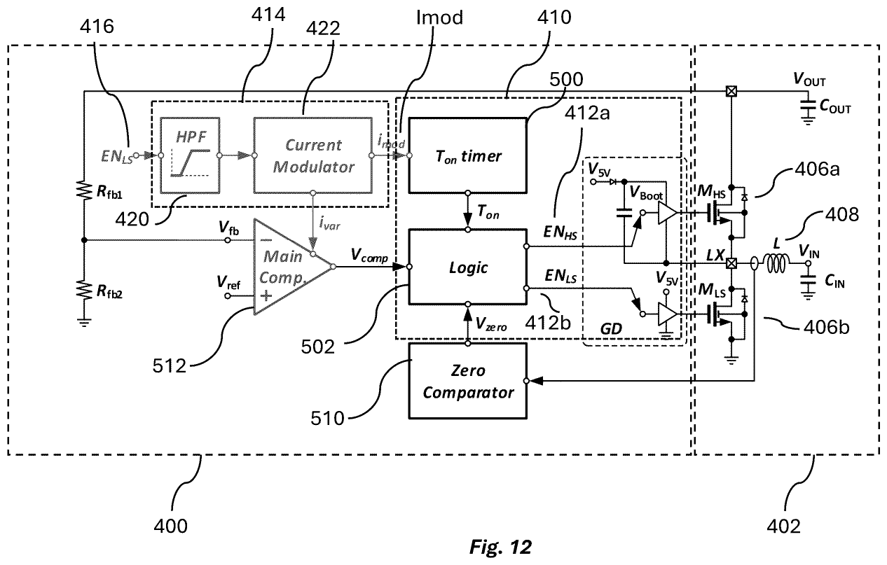

FIG. 12 is a schematic of a specific embodiment of the controller 400 and the switching converter 402 in accordance with a fifth embodiment of the present disclosure. In the present embodiment, the current modulator 422 is configured to apply the first signal 416 to the comparator 512 as a variable bias current ivar to reduce a propagation delay of the comparator 512.

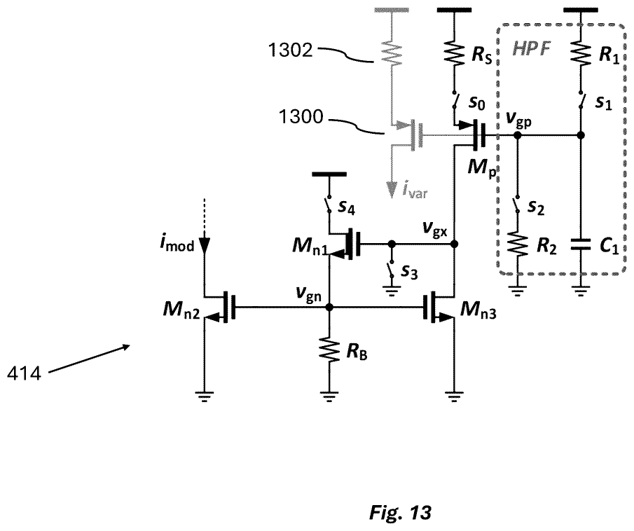

FIG. 13 is a schematic of a specific embodiment of the load current determination circuit 414. The present embodiment comprises a transistor 1300 and a resistor 1302 configured to generate the variable bias current ivar.

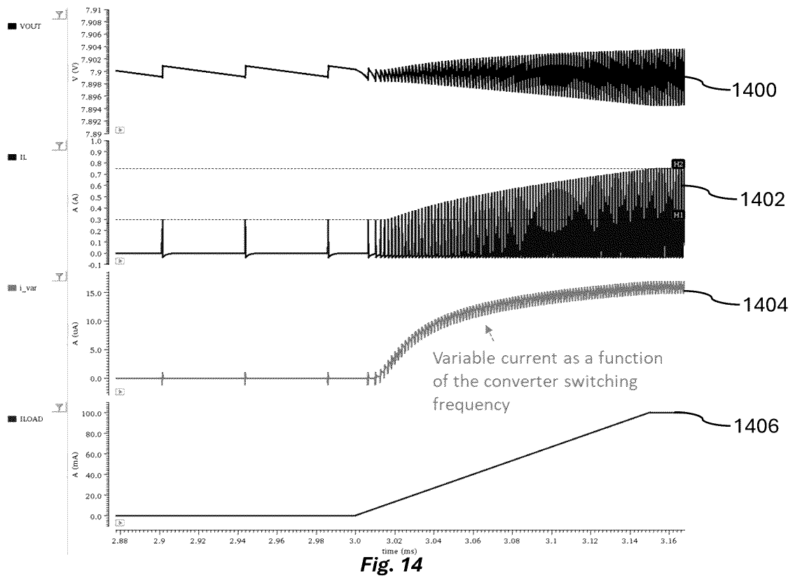

FIG. 14 shows simulation results for a practical implementation of the controller 400 and the switching converter 402 of FIG. 12 using the specific embodiment of the load current determination circuit 414 as presented in FIG. 13. There is shown: the output voltage (a trace 1400), the inductor current (a trace 1402), the variable bias current i_var (a trace 1404) and the load current IL (a trace 1406).

Output load dependent modulating current of the proposed implementation can be simultaneously applied to various regulation sub-blocks of a DC/DC converter to boost the performance. FIG. 5, and FIG. 6, showed modulation current being applied to Ton-Timer and peak current sensor, respectively. In addition to that, the modulating current can be also applied to the main comparator block in the form of variable bias current, as shown in FIG. 12. Such variable biasing current can substantially reduce the propagation delay of the comparator 512 which results in a much more accurate input signal cross-over detecting capabilities. Applying of the modulating current is not limited to the system sub-blocks that have been mentioned so far and can be more broadly used to improve the performance. As previously described, the modulating current is proportional to the output load, meaning that it doesn't contribute to the quiescent current of the converter (no light-load efficiency degradation) and only increases as the load current is being applied to the output of the converter.

The circuit implementation example of FIG. 13 shows that the proposed implementation is very straightforward to implement in silicon, and as it does not consist of large structures, it can be a very area-efficient overall solution.

With reference to FIG. 13, the capacitor C1 is being charged during the tri-state phase of the converter and discharged during the de-magnetization phase. Which means, that as the load current of the converter increases, the tri-state phase gets shorter and consequently the voltage node vgp will get lower. Since the voltage node vgp is also the gate terminal of the PMOS device Mp, a lower voltage value results in this device being turned on more and having a larger current flowing through its channel. The current through the device Mp can be used directly as a modulating current. This is illustrated by adding the additional device compared with the embodiment shown in FIG. 10, which generates the current ivar.

Such variable current increases proportional to the converter load current, as illustrated in FIG. 14. The waveforms show a slow load transient applied to the DC/DC converter. Initially, as the load current is low, the tri-state phase duration is long, and no variable current is flowing. However, as the load current is increased, the tri-state phase gets shorter, and the variable current starts flowing. The generated variable current ivar is therefore proportional to the output load current.

Embodiments of the present disclosure may provide a simple, zero IQ and area-efficient solution of having a load-dependent (adaptive) inductor peak current in the context of direct-control DC/DC converters, thereby mitigating, or overcoming, problems with known systems.

Embodiments of the present disclosure generate an output load proportional information inside of a DC/DC converter which can then be used for adjusting various control parameters.

Embodiments of the present disclosure may be beneficial in a DC/DC converter environment, for example Boost or Buck, having DCM operation. In particular, the proposed scheme allows effectively generating an output load proportional information, which can be used to adjust various control parameters, this way substantially improving the performance of a regulator.

Common reference numerals between Figures represent common features.

Various improvements and modifications may be made to the above without departing from the scope of the disclosure.

1. A controller for a switching converter for receiving an input voltage, generating an output voltage and providing a load current to an electrical load, the switching converter comprising:
one or more power switches; and
an inductor;
wherein the controller is configured to drive a switching operation of the one or more power switches to provide:
a magnetization phase where an inductor current flowing through the inductor increases to a peak current value that is dependent on the load current; and
a demagnetization phase where the inductor current decreases from the peak current value;
wherein the controller the controller comprises:
a switch driving circuit configured to provide one or more switch driving signals, each of the one or more switch driving signals being configured to control the switching state of one of the one or more power switches, thereby driving the switching operation of the one or more power switches; and
a load current determination circuit configured to:
receive a first signal that is dependent on the load current; and
adjust the one or more switch driving signals using the first signal to provide the peak current value that is dependent on the load current.

2. The controller of claim 1, wherein the peak current value is proportional to the load current.

3. The controller of claim 1, wherein:
the first signal is one of the switch driving signals; and
the load current determination circuit comprises:
a high pass filter configured to filter the first signal; and
a current modulator configured to:
receive the first signal after filtering;
convert the first signal from frequency information to current information that is proportional to the load current; and
adjust the one or more switch driving signals using the first signal after conversion.

4. The controller of claim 1, wherein the switch driving circuit comprises:
an on-time circuit configured to set a duration of the magnetization phase;
wherein the load current determination circuit is configured to control the duration of the magnetization phase set by the on-time circuit depending on the first signal, thereby adjusting the one or more switch driving signals using the first signal to provide the peak current value that is dependent on the load current.

5. The controller of claim 4, wherein:
the switch driving circuit comprises a logic circuit configured to provide the one or more switch driving signals; and
the on-time circuit is configured to set the duration of the magnetization phase by providing an on-time signal to the logic circuit.

6. The controller of claim 5, further comprising a zero comparator configured to:
detect when the inductor current is approximately zero; and
to provide a signal to the logic circuit indicating the end of the demagnetization phase.

7. The controller of claim 5, further comprising a comparator configured to:
receive a feedback voltage that is dependent on the output voltage;
receive a reference voltage;
compare the feedback voltage and the reference voltage; and
provide a comparator output signal that is dependent on the comparison between the feedback voltage and the reference voltage;
wherein the logic circuit is configured to receive the comparator output signal and to provide the one or more switch driving signals that are each dependent on the comparator output signal.

8. The controller of claim 7, wherein:
the first signal is one of the switch driving signals; and
the load current determination circuit comprises:
a high pass filter configured to filter the first signal; and
a current modulator configured to:
receive the first signal after filtering;
convert the first signal from frequency information to current information that is proportional to the load current; and
adjust the one or more switch driving signals using the first signal after conversion.

9. The controller of claim 8, wherein the current modulator is configured to apply the first signal to the comparator as a variable bias current to reduce a propagation delay of the comparator.

10. The controller of claim 1, wherein the switch driving circuit comprises a peak current sensing circuit configured to:
sense the inductor current;
compare the inductor current to a reference peak current value; and
switch the switching operation from the magnetisation phase to the demagnetisation phase when the inductor current is approximately equal to the reference peak current value;
wherein the load current determination circuit is configured to adjust the reference peak current value depending on the first signal, thereby adjusting the one or more switch driving signals using the first signal to provide the peak current value that is dependent on the load current.

11. The controller of claim 10, wherein:
the switch driving circuit comprises a logic circuit configured to provide the one or more switch driving signals; and
the peak current sensing circuit is configured to adjust the reference peak current by providing a peak current reference adjustment signal to the logic circuit.

12. The controller of claim 11 comprising a zero comparator configured to:
detect when the inductor current is approximately zero; and
to provide a signal to the logic circuit indicating the end of the demagnetization phase.

13. The controller of claim 11, further comprising a comparator configured to:
receive a feedback voltage that is dependent on the output voltage;
receive a reference voltage;
compare the feedback voltage and the reference voltage; and
provide a comparator output signal that is dependent on the comparison between the feedback voltage and the reference voltage;
wherein the logic circuit is configured to receive the comparator output signal and to provide the one or more switch driving signals that are each dependent on the comparator output signal.

14. The controller of claim 1, wherein the switching converter is a buck converter, a boost converter or a buck-boost converter.

15. The controller of claim 14, wherein:
the switching converter is a boost converter; and
the power switches comprises a high side switch and a low side switch.

16. The controller of claim 15, further comprising a switch driving circuit configured to:
provide a high side switch driving signal to the high side switch; and
provide a low side switch driving signal to the low side switch;
wherein the high and low side switch driving signals are configured to control the switching state of their respective power switches, thereby driving the switching operation of the power switches.

17. The controller of claim 5, wherein the high pass filter comprises:
a first resistor coupled to a first capacitor via a first switch, the first capacitor being coupled to the first switch at a filter output node;
a second resistor coupled to the filter output node via a second switch;
wherein:
the first switch is configured to be driven by a first digital signal that is in a high state when the switching converter is operating in a tri-state phase and is otherwise in a low state;
the second switch is configured to be driven by a second digital signal that is in a high state during the demagnetization phase and is otherwise in a low state; and
the high pass filter is configured to provide the filtered first signal to the current modulator at the filter output node.

18. The controller of claim 17, wherein the current modulator comprises:
a source degeneration resistor coupled to a first transistor via a first low resistance switch, a gate of the first transistor being coupled to the filter output node;
a current mirror comprising:
a second transistor coupled to the first transistor via a first node;
a third transistor having its gate coupled to a gate of the second transistor at a second node, and configured to provide a first modulation current at a current modulator output node;
a fourth transistor having a first terminal coupled to a second low resistance switch, a second terminal coupled to a biasing resistor at the second node, and a gate coupled to the first node; and
a third low resistance switch coupled to the first node;
wherein:
the first and second low resistance switches are each configured to be driven by the first signal and the third low resistance switch is configured to be driven by an inverted first signal; and
the current modulator is configured to adjust the one or more switch driving signals using the first modulation current, thereby adjusting the one or more switch driving signals using the first signal after conversion.

19. The controller of claim 18, wherein:
the switch driving circuit comprises an on-time circuit configured to set a duration of the magnetization phase; and
the load current determination circuit is configured to control the duration of the magnetization phase set by the on-time circuit depending on the first signal using the first modulation current, thereby adjusting the one or more switch driving signals using the first signal to provide the peak current value that is dependent on the load current.

20. The controller of claim 19, wherein:
the switch driving circuit comprises a logic circuit configured to provide the one or more switch driving signals;
the on-time circuit is configured to set the duration of the magnetization phase by providing an on-time signal to the logic circuit; and
the controller comprises a comparator configured to:
receive a feedback voltage that is dependent on the output voltage;
receive a reference voltage;
compare the feedback voltage and the reference voltage; and
provide a comparator output signal that is dependent on the comparison between the feedback voltage and the reference voltage;
wherein the logic circuit is configured to receive the comparator output signal and to provide the one or more switch driving signals that are each dependent on the comparator output signal.

21. The controller of claim 20, wherein the current modulator comprises:
a fifth transistor having its gate coupled to the gate of the first transistor; and
a third resistor coupled in series with the fifth transistor;
wherein:
the third resistor and the fifth transistor are configured to generate a variable bias current; and
the current modulator is configured to apply the first signal to the comparator as the variable bias current to reduce a propagation delay of the comparator.

22. The controller of claim 18, wherein the switch driving circuit comprises a peak current sensing circuit configured to:
sense the inductor current;
compare the inductor current to a reference peak current value; and
switch the switching operation from the magnetisation phase to the demagnetisation phase when the inductor current is approximately equal to the reference peak current value;
wherein the load current determination circuit is configured to adjust the reference peak current value depending on the first signal using the first modulation current, thereby adjusting the one or more switch driving signals using the first signal to provide the peak current value that is dependent on the load current.

23. A power converter system comprising a switching converter for receiving an input voltage, generating an output voltage and providing a load current to an electrical load, the switching converter comprising:
one or more power switches;
an inductor; and
a controller configured to drive a switching operation of the one or more power switches to provide:
a magnetization phase where an inductor current flowing through the inductor increases to a peak current value that is dependent on the load current; and
a demagnetization phase where the inductor current decreases from the peak current value;
wherein the controller comprises:
a switch driving circuit configured to provide one or more switch driving signals, each of the one or more switch driving signals being configured to control the switching state of one of the one or more power switches, thereby driving the switching operation of the one or more power switches; and
a load current determination circuit configured to:
receive a first signal that is dependent on the load current; and
adjust the one or more switch driving signals using the first signal to provide the peak current value that is dependent on the load current.

24. A method of controlling a switching converter for receiving an input voltage, generating an output voltage and providing a load current to an electrical load,
the switching converter comprising:
one or more power switches; and
an inductor;
wherein the method comprises:
driving a switching operation of the one or more power switches using a controller to provide:
a magnetization phase where an inductor current flowing through the inductor increases to a peak current value that is dependent on the load current; and
a demagnetization phase where the inductor current decreases from the peak current value;
providing, using a switch driving circuit, one or more switch driving signals, each of the one or more switch driving signals being configured to control the switching state of one of the one or more power switches, thereby driving the switching operation of the one or more power switches;
receiving, at a load current determination circuit, a first signal that is dependent on the load current; and
adjusting, using the load current determination circuit, the one or more switch driving signals using the first signal to provide the peak current value that is dependent on the load current.
